(19) United States
(12) Patent Application Publication
(10) Pub. No.: US 2013/0035103 A1
(43) Pub. Date: Feb. 7, 2013

(54) METHODS FOR TRANSMIT ANTENNA SWITCHING DURING UPLINK ACCESS PROBING

(71) Applicants: Syed A. Mujtaba, Santa Clara, CA (US); Youngjae Kim, Cupertino, CA (US); Kee-Bong Song, Santa Clara, CA (US); Xiaowen Wang, Cupertino, CA (US)

(72) Inventors: Syed A. Mujtaba, Santa Clara, CA (US); Youngjae Kim, Cupertino, CA (US); Kee-Bong Song, Santa Clara, CA (US); Xiaowen Wang, Cupertino, CA (US)

(21) Appl. No.: 13/195,494

(22) Filed: Aug. 1, 2011

(51) Int. Cl. H04W 74/00

(52) U.S. Cl. 455/450; 455/509

(57) ABSTRACT

Electronic devices may be provided that contain wireless communication circuitry. The wireless communication circuitry may include radio-frequency transceiver circuitry coupled to first and second antennas. An electronic device may send network access probe signals to a base station in a wireless network. If the base station responds with a corresponding acknowledgement, the electronic device and base station may establish a wireless communication link such as a cellular telephone link. In response to failure to receive the acknowledgement signal from the base station, the electronic device may increase the transmit power of a successive network access probe signal. The electronic device may switch between use of the first and second antennas when transmitting the network access probe signals. The electronic device may alternate between the first and second antennas or may use other antenna usage patterns.

### BACKGROUND

This relates generally to wireless communications circuitry, and more particularly, to electronic devices that have wireless communication circuitry with multiple antennas.

Electronic devices such as portable computers and cellular telephones are often provided with wireless communication capabilities. For example, electronic devices may use long-range wireless communications circuitry such as cellular telephone circuitry and WiMax (IEEE 802.16) circuitry. Electronic devices may also use short-range wireless communication circuitry such as WiFi® (IEEE 802.11) circuitry and Bluetooth® circuitry.

Antenna performance affects the ability of a user to take advantage of the wireless capabilities of an electronic device. If antenna performance is not satisfactory, calls may be dropped or data transfer rates may become undesirably slow. To ensure that antenna performance meets design criteria, it may sometimes be desirable to provide an electronic device with multiple antennas. In some situations, control circuitry (for example, control circuitry on which software runs) within a device may be able to switch between antennas to ensure that an optimal antenna is being used.

Link setup operations in devices such as cellular telephones are typically performed using a single antenna. When a device desires to establish a communication link with a base station in a wireless network, the device transmits a series of network access probe signals. Upon receipt of an acknowledgement from the base station, a communications link may be set up between the device and the network.

To avoid situations in which the transmitted traffic from one device interferes with the traffic of another device in a network, each device is required by network protocols to minimize transmit powers whenever possible. During link setup, a device initially uses a relatively low power when transmitting its network access probe signals. If this transmit power level is sufficient, the network will receive the network access probe signals and will respond by producing a corresponding acknowledgement signal. A communication link may then be set up between the device and the device uses the successful transmit power level.

If the initially chosen transmit power is insufficient, the network will not receive the network access probe signals and will not send a corresponding acknowledgement to the device. When no acknowledgement signals are received by the device, the device increments its transmit power level and sends another network access probe signal. This process may be repeated until a satisfactory transmit power for the device has been identified.

Although conventional network access probing schemes of this type are generally satisfactory, use of a single antenna in sending the network access probe signals can make it impossible to access a network in situations in which antenna performance is temporarily impaired due to the presence of an external object in the vicinity of the antenna.

It would therefore be desirable to be able to provide improved ways for electronic devices such as devices with multiple antennas to access a wireless network.

### SUMMARY

Electronic devices may be provided that contain wireless communication circuitry. The wireless communication circuitry may include radio-frequency transceiver circuitry coupled to multiple antennas. For example, the wireless communication circuitry may be coupled to first and second antennas.

An electronic device may send network access probe signals to a base station in a wireless network. If the base station responds with a corresponding acknowledgement, the electronic device and base station may establish a wireless communication link such as a cellular telephone link. In response to failure to receive the acknowledgement signal from the base station, the electronic device may increase the transmit power for its next network access probe signal.

The electronic device may switch between use of the first and second antennas when transmitting the network access probe signals. For example, the electronic device may alternate between the first and second antennas. Other patterns of antenna usage during transmission of the network access probe signals may also be used.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with wireless communication circuitry having multiple antennas in accordance with an embodiment of the present invention.

FIG. 2 is a schematic diagram of a wireless network including a base station and an illustrative electronic device with wireless communication circuitry having multiple antennas in accordance with an embodiment of the present invention.

FIG. 3 is a diagram of illustrative wireless circuitry including multiple antennas and circuitry for controlling use of the antennas in accordance with an embodiment of the present invention.

FIG. 4 is a graph showing how an electronic device with multiple antennas can change which antenna is being used to transmit network access probe signals as a function of time when requesting access from a network in accordance with an embodiment of the present invention.

FIG. 5 is a flow chart showing operations involved in controlling an electronic device with multiple antennas during the transmission of network access probe signals in accordance with an embodiment of the present invention.

FIG. 6 is a graph of an illustrative antenna usage pattern that an electronic device with at least two antennas can use in transmitting network access probe signals when requesting access from a network in accordance with an embodiment of the present invention.

FIG. 7 is a graph of another illustrative antenna usage pattern that an electronic device with at least two antennas can use in transmitting network access probe signals when requesting access from a network in accordance with an embodiment of the present invention.

FIG. 8 is a graph of an illustrative antenna usage pattern that an electronic device with more than two antennas can use in transmitting network access probe signals when requesting access from a network in accordance with an embodiment of the present invention.

### DETAILED DESCRIPTION

Electronic devices may be provided with wireless communication circuitry. The wireless communications circuitry may be used to support wireless communications in multiple wireless communication bands. The wireless communication circuitry may include multiple antennas arranged to implement an antenna diversity system.

The antennas can include loop antennas, inverted-F antennas, strip antennas, planar inverted-F antennas, slot antennas, hybrid antennas that include antenna structures of more than one type, or other suitable antennas. Conductive structures for the antennas may be formed from conductive electronic device structures such as conductive housing structures (e.g., a ground plane and part of a peripheral conductive housing member or other housing structures), traces on substrates such as traces on plastic, glass, or ceramic substrates, traces on flexible printed circuit boards (“flex circuits”), traces on rigid printed circuit boards (e.g., fiberglass-filled epoxy boards), sections of patterned metal foil, wires, strips of conductor, other conductive structures, or conductive structures that are formed from a combination of these structures.

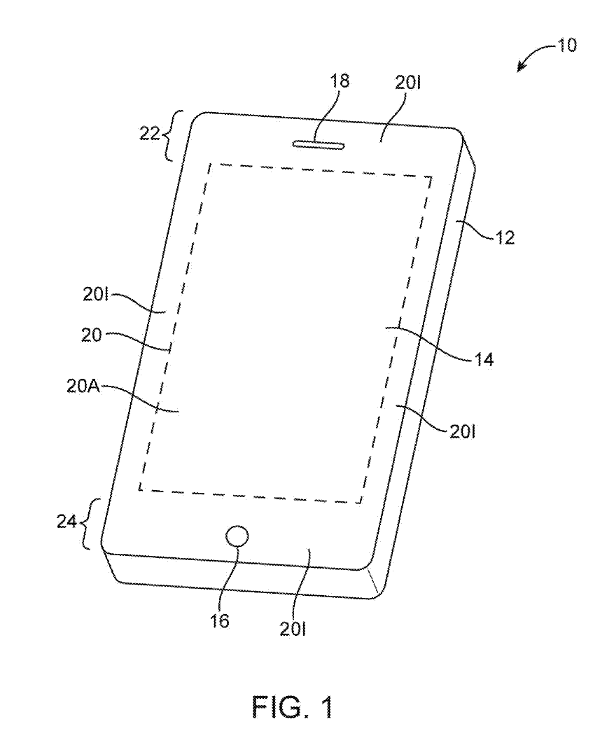

An illustrative electronic device of the type that may be provided with one or more antennas (e.g., two antennas, three antennas, four antennas, five or more antennas, etc.) is shown in FIG. 1. Electronic device 10 may be a portable electronic device or other suitable electronic device. For example, electronic device 10 may be a laptop computer, a tablet computer, a somewhat smaller device such as a wrist-watch device, pendant device, headphone device, earpiece device, or other wearable or miniature device, a cellular telephone, a media player, etc.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material. In other situations, housing 12 or at least some of the structures that make up housing 12 may be formed from metal elements.

Device 10 may, if desired, have a display such as display 14. Display 14 may, for example, be a touch screen that incorporates capacitive touch electrodes. Display 14 may include image pixels formed form light-emitting diodes (LEDs), organic LEDs (OLEDs), plasma cells, electronic ink elements, liquid crystal display (LCD) components, or other suitable image pixel structures. A cover glass layer may cover the surface of display 14. Portions of display 14 such as peripheral regions 201 may be inactive and may be devoid of image pixel structures. Portions of display 14 such as rectangular central portion 20A (bounded by dashed line 20) may correspond to the active part of display 14. In active display region 20A, an array of image pixels may be used to display images for a user.

The cover glass layer that covers display 14 may have openings such as a circular opening for button 16 and a speaker port opening such as speaker port opening 18 (e.g., for an ear speaker for a user). Device 10 may also have other openings (e.g., openings in display 14 and/or housing 12 for accommodating volume buttons, ringer buttons, sleep buttons, and other buttons, openings for an audio jack, data port connectors, removable media slots, etc.).

Housing 12 may include a peripheral conductive member such as a bezel or band of metal that runs around the rectangular outline of display 14 and device 10 (as an example). The peripheral conductive member may be used in forming the antennas of device 10 if desired.

Antennas may be located along the edges of device 10, on the rear or front of device 10, as extending elements or attachable structures, or elsewhere in device 10. With one suitable arrangement, which is sometimes described herein as an example, device 10 may be provided with one or more antennas at lower end 24 of housing 12 and one or more antennas at upper end 22 of housing 12. Locating antennas at opposing ends of device 10 (i.e., at the narrower end regions of display 14 and device 10 when device 10 has an elongated rectangular shape of the type shown in FIG. 1) may allow these antennas to be formed at an appropriate distance from ground structures that are associated with the conductive portions of display 14 (e.g., the pixel array and driver circuits in active region 20A of display 14).

If desired, a first cellular telephone antenna may be located in region 24 and a second cellular telephone antenna may be located in region 22. Antenna structures for handling satellite navigation signals such as Global Positioning System signals or wireless local area network signals such as IEEE 802.11 (WiFi®) signals or Bluetooth® signals may also be provided in regions 22 and/or 24 (either as separate additional antennas or as parts of the first and second cellular telephone antennas). Antenna structures may also be provided in regions 22 and/or 24 to handle WiMax (IEEE 802.16) signals.

In regions 22 and 24, openings may be formed between conductive housing structures and printed circuit boards and other conductive electrical components that make up device 10. These openings may be filled with air, plastic, or other dielectrics. Conductive housing structures and other conductive structures may serve as a ground plane for the antennas in device 10. The openings in regions 22 and 24 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element such as an inverted-F antenna resonating element formed from part of a conductive peripheral housing structure in device 10 from the ground plane, or may otherwise serve as part of antenna structures formed in regions 22 and 24.

Antennas may be formed in regions 22 and 24 that are identical (i.e., antennas may be formed in regions 22 and 24 that each cover the same set of cellular telephone bands or other communication bands of interest). Due to layout constraints or other design constraints, it may not be desirable to use identical antennas. Rather, it may be desirable to implement the antennas in regions 22 and 24 using different designs. For example, the first antenna in region 24 may cover all cellular telephone bands of interest (e.g., four or five bands) and the second antenna in region 22 may cover a subset of the four or five bands handled by the first antenna. Arrangements in which the antenna in region 24 handles a subset of the bands handled by the antenna in region 22 (or vice versa) may also be used. Tuning circuitry may be used to tune this type of antenna in real time to cover a either a first subset of bands or a second subset of bands and thereby cover all bands of interest.

Antenna operation can be disrupted when an antenna in device 10 is blocked by an external object such as a user's hand, when device 10 is placed near objects that interfere with proper antenna operation, or due to other factors (e.g., device orientation relative to its surroundings, etc.). To ensure that communication links are properly set up when requesting network access from a wireless network, device 10 can automatically switch between different antennas in device 10 when transmitting network access probe signals.

Antenna diversity systems in which device 10 has a primary antenna and a secondary antenna are sometimes described herein as an example. This is, however, merely illustrative. Device 10 may use an antenna diversity arrangement that is based on three or more antennas, may use antennas that are substantially identical (e.g., in band coverage, in efficiency, etc.), or may use other types of antenna configurations.

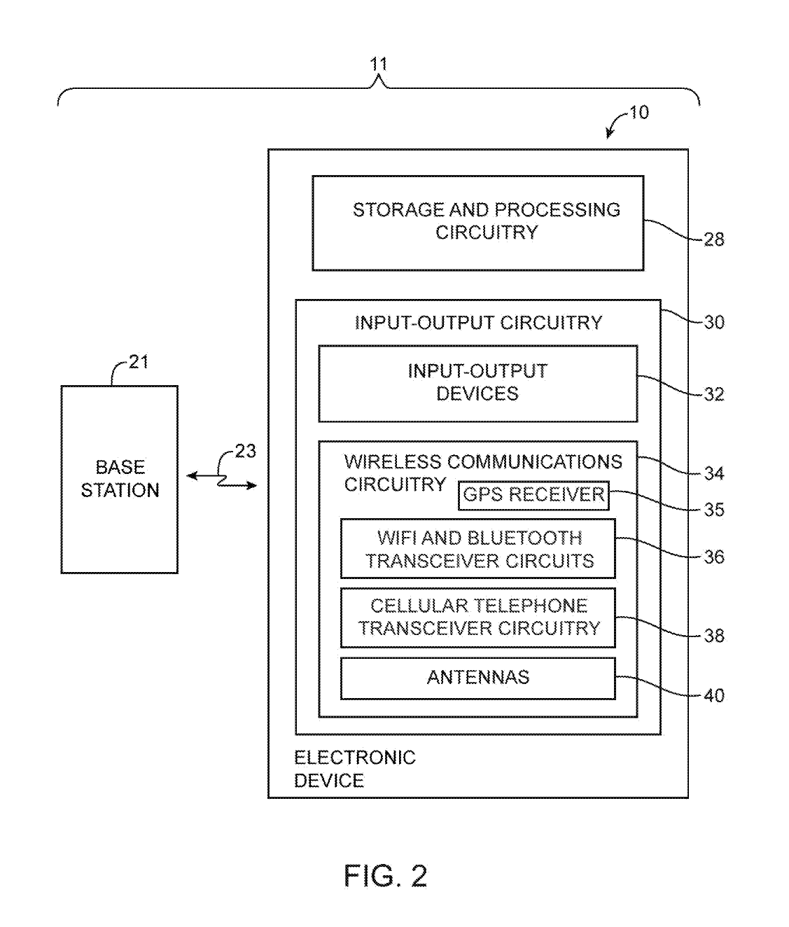

A schematic diagram of a system in which electronic device 10 may operate is shown in FIG. 2. As shown in FIG. 2, system 11 may include wireless network equipment such as base station 21. Base stations such as base station 21 may be associated with a cellular telephone network or other wireless networking equipment. Device 10 may communicate with base station 21 over wireless link 23 (e.g., a cellular telephone link or other wireless communication links).

Device 10 may include control circuitry such as storage and processing circuitry 28. Storage and processing circuitry 28 may include storage such as hard disk drive storage, non-volatile memory (e.g., flash memory or other electrically-programmable-read-only memory configured to form a solid state drive), volatile memory (e.g., static or dynamic random-access-memory), etc. Processing circuitry in storage and processing circuitry 28 and other control circuits such as control circuits in wireless communication circuitry 34 may be used to control the operation of device 10. This processing circuitry may be based on one or more microprocessors, microcontrollers, digital signal processors, baseband processors, power management units, audio codec chips, application specific integrated circuits, etc.

Storage and processing circuitry 28 may be used to run software on device 10, such as internet browsing applications, voice-over-internet-protocol (VOIP) telephone call applications, email applications, media playback applications, operating system functions, etc. To support interactions with external equipment such as base station 21, storage and processing circuitry 28 may be used in implementing communication protocols. Communications protocols that may be implemented using storage and processing circuitry 28 include internet protocols, wireless local area network protocols (e.g., IEEE 802.11 protocols—sometimes referred to as WiFi®), protocols for other short-range wireless communication links such as the Bluetooth® protocol, IEEE802.16 (WiMax) protocols, cellular telephone protocols such as the Long Term Evolution (LTE) protocol, Global System for Mobile Communications (GSM) protocol, Code Division Multiple Access (CDMA) protocol, and Universal Mobile Telecommunications System (UMTS) protocol, etc.

Circuitry 28 may be configured to implement control algorithms that control the use of antennas in device 10. For example, circuitry 28 may configure wireless circuitry 34 to switch a particular antenna into use for transmitting and/or receiving signals. In some scenarios, circuitry 28 may be used in gathering sensor signals and signals that reflect the quality of receive signals (e.g., bit error rate measurements, signal-to-noise ratio measurements, measurements on the amount of power associated with incoming wireless signals, etc.). This information may be used in controlling which antenna is used. Antenna selections can also be made based on other criteria.

Input-output circuitry 30 may be used to allow data to be supplied to device 10 and to allow data to be provided from device 10 to external devices. Input-output circuitry 30 may include input-output devices 32. Input-output devices 32 may include touch screens, buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 32 and may receive status information and other output from device 10 using the output resources of input-output devices 32.

Wireless communication circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals.

Wireless communication circuitry 34 may include satellite navigation system receiver circuitry such as Global Positioning System (GPS) receiver circuitry 35 (e.g., for receiving satellite positioning signals at 1575 MHz). Transceiver circuitry 36 may handle 2.4 GHz and 5 GHz bands for WiFi® (IEEE 802.11) communications and may handle the 2.4 GHz Bluetooth® communication band. Circuitry 34 may use cellular telephone transceiver circuitry 38 for handling wireless communications in cellular telephone bands such as bands at 850 MHz, 900 MHz, 1800 MHz, 1900 MHz, and 2100 MHz or other cellular telephone bands of interest. Wireless communication circuitry 34 can include circuitry for other short-range and long-range wireless links if desired (e.g., WiMax circuitry, etc.). Wireless communication circuitry 34 may, for example, include, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communication circuitry 34 may include antennas 40. Antennas 40 may be formed using any suitable antenna types. For example, antennas 40 may include antennas with resonating elements that are formed from loop antenna structure, patch antenna structures, inverted-F antenna structures, closed and open slot antenna structures, planar inverted-F antenna structures, helical antenna structures, strip antennas, monopoles, dipoles, hybrids of these designs, etc. Different types of antennas may be used for different bands and combinations of bands. For example, one type of antenna may be used in forming a local wireless link antenna and another type of antenna may be used in forming a remote wireless link antenna. As described in connection with FIG. 1, there may be multiple cellular telephone antennas in device 10. For example, there may be a first cellular telephone antenna in region 24 of device 10 and a second cellular telephone antenna in region 22 of device 10. These antennas may be fixed or may be tunable.

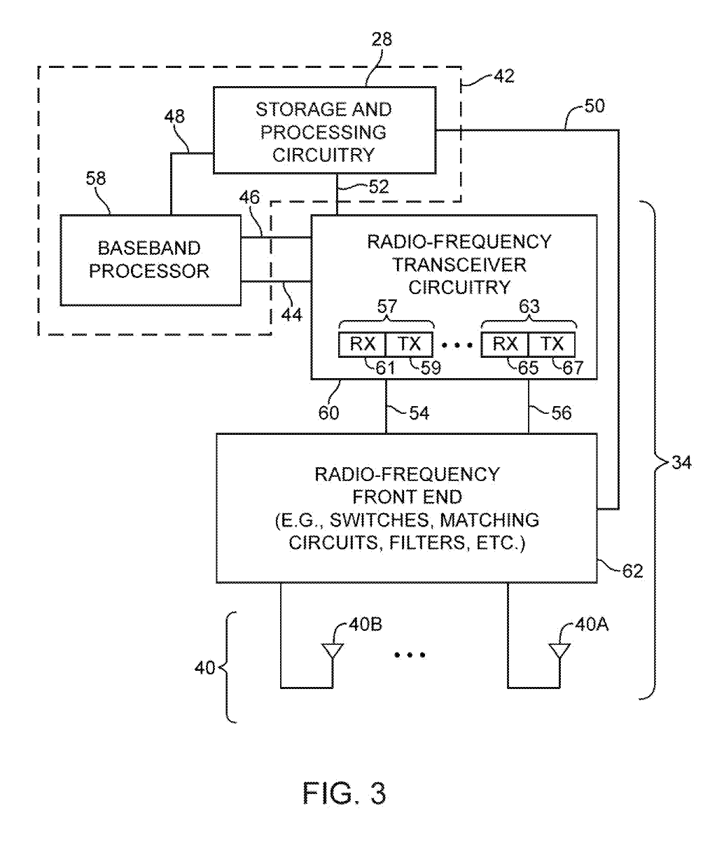

Device 10 can be controlled by control circuitry that is configured to store and execute control code for implementing control algorithms (e.g., antenna diversity control algorithms and other wireless control algorithms). As shown in FIG. 3, control circuitry 42 may include storage and processing circuitry 28 (e.g., a microprocessor, memory circuits, etc.) and may include baseband processor 58. Baseband processor 58 may form part of wireless circuitry 34 and may include memory and processing circuits (i.e., baseband processor 58 may be considered to form part of the storage and processing circuitry of device 10).

Baseband processor 58 may provide data to storage and processing circuitry 28 via path 48. The data on path 48 may include raw and processed data associated with wireless (antenna) performance metrics such as received power, transmitted power, frame error rate, bit error rate, signal-to-noise ratio, information on whether responses (acknowledgements) are being received from a cellular telephone tower corresponding to requests from the electronic device, information on whether a network access procedure has succeeded, information on how many re-transmissions are being requested over a cellular link between the electronic device and a cellular tower, information on whether a loss of signaling message has been received, and other information that is reflective of the performance of wireless circuitry 34. This information may be analyzed by storage and processing circuitry 28 and/or processor 58 and, in response, storage and processing circuitry 28 (or, if desired, baseband processor 58) may issue control commands for controlling wireless circuitry 34. For example, storage and processing circuitry 28 may issue control commands on path 52 and path 50.

Wireless circuitry 34 may include radio-frequency transceiver circuitry such as radio-frequency transceiver circuitry 60 and radio-frequency front-end circuitry 62. Radio-frequency transceiver circuitry 60 may include one or more radio-frequency transceivers such as transceivers 57 and 63 (e.g., one or more transceivers that are shared among antennas, one transceiver per antenna, etc.). In the illustrative configuration of FIG. 3, radio-frequency transceiver circuitry 60 has a first transceiver such as transceiver 57 that is associated with path (port) 54 (and which may be associated with path 44) and a second transceiver such as transceiver 63 that is associated with path (port) 56 (and which may be associated with path 46). Transceiver 57 may include a transmitter such as transmitter 59 and a receiver such as receiver 61 or may contain only a receiver (e.g., receiver 61) or only a transmitter (e.g., transmitter 59). Transceiver 63 may include a transmitter such as transmitter 67 and a receiver such as receiver 65 or may contain only a receiver (e.g., receiver 65) or only a transmitter (e.g., transmitter 59).

Baseband processor 58 may receive digital data that is to be transmitted from storage and processing circuitry 28 and may use path 46 and radio-frequency transceiver circuitry 60 to transmit corresponding radio-frequency signals. Radio-frequency front end 62 may be coupled between radio-frequency transceiver 60 and antennas 40 and may be used to convey the radio-frequency signals that are produced by transmitters 59 and 67 to antennas 40. Radio-frequency front end 62 may include radio-frequency switches, impedance matching circuits, filters, and other circuitry for forming an interface between antennas 40 and radio-frequency transceiver 60.

Incoming radio-frequency signals that are received by antennas 40 may be provided to baseband processor 58 via radio-frequency front end 62, paths such as paths 54 and 56, receiver circuitry in radio-frequency transceiver 60 such as receiver 61 at port 54 and receiver 63 at port 56, and paths such as paths 44 and 46. Baseband processor 58 may convert these received signals into digital data that is provided to storage and processing circuitry 28.

Radio-frequency front end 62 may include a switch that is used to connect transceiver 57 to antenna 40B and transceiver 63 to antenna 40A or vice versa. The switch may be configured by control signals received from control circuitry 42 over path 50. Circuitry 42 may, for example, adjust the switch to select which antenna is being used to transmit radio-frequency signals (e.g., when it is desired to share a single transmitter in transceiver 60 between two antennas).

If desired, antenna selection may be made by selectively activating and deactivating transceivers without using a switch in front end 62. For example, if it is desired to use antenna 40B, transceiver 57 (which may be coupled to antenna 40B through circuitry 62) may be activated and transceiver 63 (which may be coupled to antenna 40A through circuitry 62) may be deactivated. If it is desired to use antenna 40A, circuitry 42 may activate transceiver 63 and deactivate transceiver 57. Combinations of these approaches may also be used to select which antennas are being used to transmit and/or receive signals.

Control operations such as operations associated with configuring wireless circuitry 34 to transmit radio-frequency signals through a desired one of antennas 40 may be performed using a control algorithm that is implemented on control circuitry 42 (e.g., using the control circuitry and memory resources of storage and processing circuitry 28 and baseband processor 58).

There is typically a control channel (downlink channel) and random access channel (uplink channel) associated with each communication band in network 11 (FIG. 2). In frequency division duplexing (FDD) systems (e.g., networks using protocols such as the LTE, GSM, CDMA, and UMTS protocols), the control channel and random access channel (and other receiving and transmitting channel pairs) are separated by a difference in frequency. In time division duplexing (TDD) systems (e.g., networks such as WiMax and WiFi networks), the control channel and random access channel (and other receiving and transmitting channel pairs) share a common frequency, but are separated in time using time division multiplexing.

During operations such as link setup operations, device 10 can send data to base station 21 using the random access channel in network 11. For example, device 10 can transmit network access probe signals to base station 21 to request that a communication link be established between device 10 and base station 21 in network 11. Base station 21 may send data to device 10 using the control channel. For example, upon successful receipt of a network access probe signal, base station 21 may send an acknowledgement to device 10 over the control channel. Device 10 and base station 21 may then proceed to set up a communication link such as link 23 of FIG. 2. Once link 23 has been established, a user of device 10 can access network 11 (e.g., a user can access network 11 for a voice telephone call or to upload or download data over link 23).

In a conventional cellular telephone with a single antenna, the cellular telephone sends network access probe signals to a base station through the antenna at sequentially increasing transmit power levels or uses a predetermined maximum transmit power if the incremented power level exceeds the maximum power that the device is capable of or is allowed to transmit by the network. Initially, when the transmitted power of the probe signals is low, the base station may not successfully receive the probe signals and may therefore fail to issue an acknowledgement. After the cellular telephone has increased the transmit power of the probe signals sufficiently, the base station will generally receive the probe signals and will respond with a corresponding acknowledgement signal. If the cellular telephone reaches its maximum allowed number of access probe transmissions with increasing transmission power set by the network before receiving an acknowledgement from the base station, the cellular telephone can send one or more additional sets of probe signals, each set starting with a probe signal at an initial low transmit power level followed by probe signals with transmit power levels that increase towards a maximum allowed transmit power level. There may be intervals of random and/or fixed duration between access probe transmissions in order to avoid collisions among other users using the same random access channel.

This type of scheme can be compromised when a user blocks the antenna with an external object. When the antenna is blocked, the base station may not receive the network access probe signals, even when the probe signals are being transmitted with their highest allowed power.

In devices such as device 10 of FIG. 2 that have multiple antennas, network access failures due to antenna blockage can be reduced by transmitting network access probe signals using more than one antenna. For example, in a configuration in which device 10 has two antennas, device 10 can alternate between the two antennas when sending network access probe signals. In devices with more than two antennas, device 10 can sequence through each of the available antennas, etc.

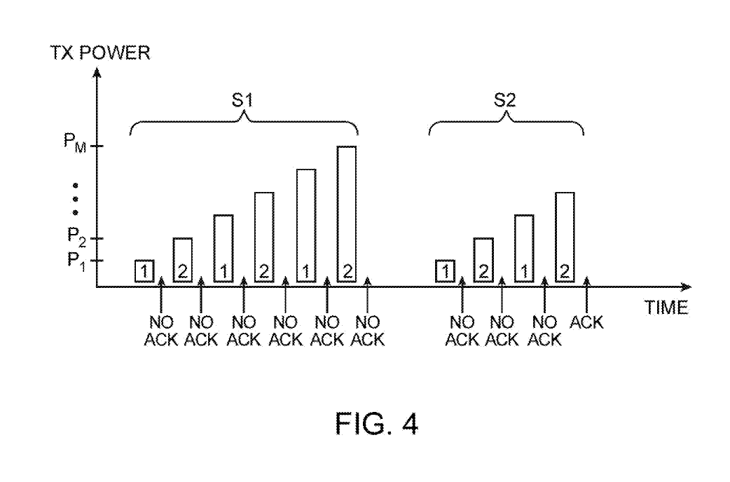

A graph in which transmit power has been plotted as a function of time while device 10 is transmitting a series of network access probe signals using multiple antennas is shown in FIG. 4. The probe signals are labeled “1” to indicate when a first antenna is being used (e.g., antenna 40A of FIG. 3) and are labeled “2” to indicate when a second antenna is being used (e.g., antenna 40B of FIG. 3). As shown in the graph, the first probe signal is transmitted by the first antenna at a relatively low transmit power of P1. This signal is not received by the base station (in this example), so no acknowledgement is sent by the base station and no acknowledgement is received by device 10 (as indicated by the “no ack” label adjacent to the first probe signal).

In response to this failure of the first probe signal, device 10 increments the power of the second probe signal to power P2 and transmits the second probe signal with a different antenna (i.e., antenna “2”). Because a different antenna is being used to transmit the second probe signal, the second probe signal has a chance of being received by base station 51, even if the first antenna is being blocked by an external object.

This process of sending the probe signals through the antennas in alternation can continue for a number of probe signals. Each successive probe signal may be sent with a different antenna and may be sent using an increased (or at least not decreased) output power until the maximum allowed number of access probe transmissions with increasing power set by the network is reached. Another set of probe signals may then be sent using the same arrangement. In the example of FIG. 4, none of the probe signals in first probe signal set S1 were successfully received at the base station and no acknowledgements were received. In a second attempt to contact base station 21, device 10 then retransmitted as second set of probe signals S2. The probe signals in set S2 were initially transmitted at lower powers (starting at power P1) and were sequentially incremented. After four probe signals, the base station successfully received the probe signals and responded by sending device 10 an acknowledgement (ack). The probe signal transmission process in the FIG. 4 example was therefore completed after sending four probe signals in probe signal set S2.

The arrangement of FIG. 4 is merely illustrative. Other patterns of antenna usage and other numbers of probe signals and sets of probe signals may be involved. In a typical CDMA system, there may be about five probe signals per set of probe signals and up to about two probe signal sets may be transmitted by device 10. In a typical GSM system, there may be about four or five probe signals per set and up to about three to four sets of probe signals may be transmitted. Each set of probe signals may be about 10-50 ms in duration (as an example). There may be a delay of several seconds (e.g., 10 seconds) between sets. Probe signals are typically separated from adjacent probe signals by about 4 ms, although this probe-signal-to-probe-signal spacing may sometimes be altered by the network (e.g., when the network imposes a random delay to help avoid interference that might otherwise arise when multiple devices are simultaneously sending probe signals to a base station).

Particularly in view of the relatively short time between probe signals, it may be desirable to use a relatively fast algorithm to determine which antenna in device 10 should be selected for each probe signal transmission. The algorithm may, for example, determine which antenna to use based on whether the probe signal transmission is odd or even (as shown in the example of FIG. 4). In this type of arrangement, device 10 may use control circuitry 42 to maintain a count of the probe signals that are being sent and may maintain information on the type of pattern that is being used to transmit probe signals (e.g., alternating odd/even or other patterns). Because it is not necessary with this type of approach to analyze sensor data or signal quality data, the determination of which antenna should be used in transmitting each network access probe signal can be made rapidly, allowing probe signals to be transmitted every few milliseconds (as an example).

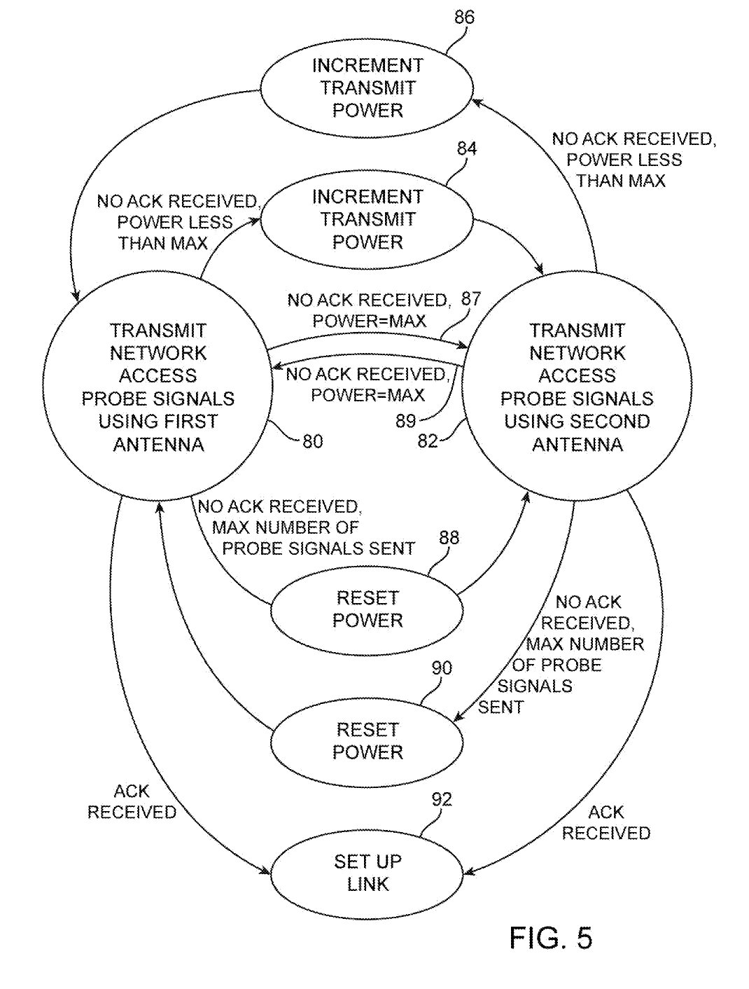

FIG. 5 is a flow chart of illustrative operations that may be involved in transmitting network access probe signals using an arrangement of the type shown in FIG. 4 in network 11. Initially, device 10 may transmit network access probe signals using a first antenna (e.g., antenna 40A) in device 10 (step 80). These probe signals may have a power (e.g., power P1 of FIG. 4) that is set based on information on received signals in the control channel.

The probe signals that are transmitted may or may not be received by base station 21. Factors that may influence the reception of the probe signals by base station 21 include the distance between the base station and the transmitting device, interference, and transmit power.

If base station 21 does not receive the probe signal, base station 21 will not issue a corresponding acknowledgement signal and no acknowledgement signal will be received by device 10. Provided that the transmit power for the failed probe signals is not yet at the maximum permitted transmit level, device 10 may then increment the transmit power (step 84). For example, if a probe signal of power P1 was transmitted at step 80, the transmit power for the next probe signal may be set to power P2, etc.

At step 82, device 10 may transmit the next probe signal using the incremented transmit power value and using a different antenna than was used during the operations of step 80 (e.g., using a second antenna in device 10 such as antenna 40B).

If no acknowledgement is received by device 10 in response to transmission of the network access probe signals of step 82 and if the current transmit power level is less than the maximum permitted power (e.g., if the transmit power is less than power Pm of FIG. 4), the transmit power may be incremented during the operations of step 86. Device 10 may then transmit the next probe signal using the first antenna (step 80).

The process may continue until the maximum transmit power (Pm of FIG. 4) is reached or until an acknowledgement signal is received from base station 21. If no acknowledgement signal is received following transmission of a network access probe signal at step 80 and if the transmit power of the probe signal has been incremented sufficiently that it has reached the maximum permitted transmit power (Pm), the second antenna can be used to transmit a network access probe signal at step 82, as illustrated by line 87. If no acknowledgement signal is received following transmission of a network access probe signal at step 82 and if the transmit power of the probe signal has reached maximum power Pm, the first antenna can be used to transmit the network access probe signal at step 80, as illustrated by line 89.

When the maximum allowed number of access probe signals for the first set (S1) of transmitted access probe signals has been transmitted, the transmit power may be reset to a relatively low value such as power P1. For example, if the second antenna is used to transmit probe signals at step 82 and no acknowledgement is received and if a network-specified maximum allowed number of access probe signals for set S1 has been transmitted, the power being used to transmit the probe signals may be reset to a relatively low value (e.g., about P1) during the operations of step 88. If the first antenna is used to transmit probe signals at step 80 and no acknowledgement is received and if a network-specified maximum allowed number of access probe signals has been transmitted, the power being used to transmit the probe signals may be set to a relatively low value (e.g., P1) during the operations of step 90.

Following a transmit power reset operation, probe signal transmission may continue in another set of probe signals (e.g., set S2 of FIG. 4). For example, a probe signal at power P1 may be transmitted using the first antenna (step 80), after which device 10 may sequentially increment the transmit power for the probe signals while alternating between the first and second antennas.

Using this technique, the transmit power for the probe signals may be reset to a relatively low value after transmission of the first set of probe signals (e.g., set S1 of FIG. 4). Following a suitable interval (e.g., a time interval of several seconds or other suitable time period), transmission of another set of probe signals can commence (i.e., probe signal set S2 of FIG. 4), starting at low power (e.g., power P1 or other suitable power). This process may repeat for multiple sets.

When the network access probe signal that is transmitted by device 10 is successfully received by base station 21 (e.g., because the transmit power for the probe signals has reached a sufficiently high level), base station 21 may transmit a corresponding acknowledgement to device 10. When the acknowledgement is received by device 10, device 10 may proceed to set up wireless communication link 23 (FIG. 2) with base station 21 (step 92). Once link 23 has been established, device 10 can communicate with base station 21 (e.g., to support a voice call or a data link with other equipment in network 11).

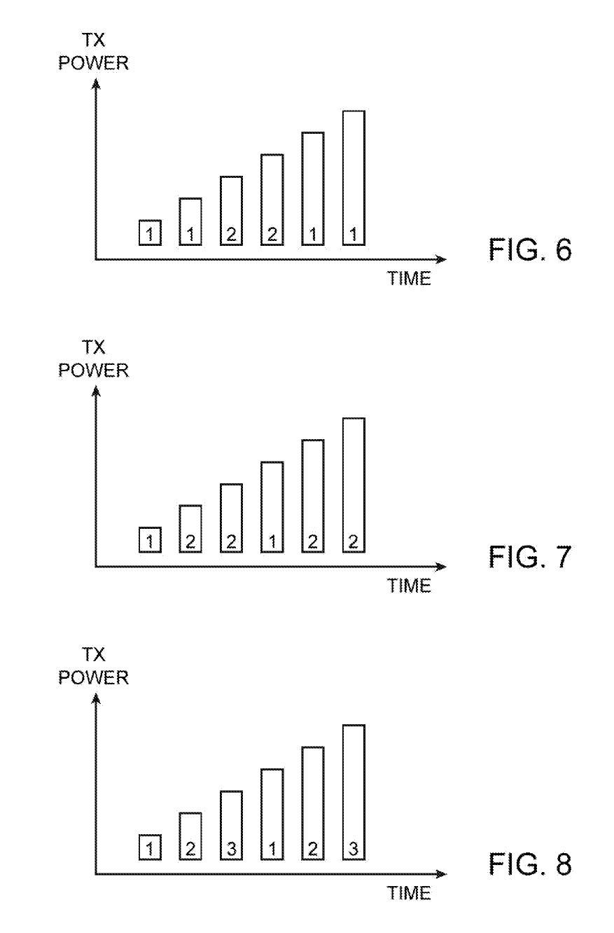

With an antenna usage pattern of the type shown in FIG. 4, device 10 alternates between using a first antenna (e.g., antenna 40A) and a second antenna (e.g., antenna 40B) when transmitting probe signals to base station 21. Other antenna usage patterns may be used when transmitting probe signals to base station 21 if desired. Examples of illustrative antenna usage patterns that may be used are shown in FIGS. 6, 7, and 8.

In the example of FIG. 6, device 10 is using first and second antennas to transmit probe signals to base station 21. With the FIG. 6 arrangement, device 10 sends multiple network access probe signals using the first antenna before switching to the second antenna. The second antenna is then used in sending multiple probe signals before reverting to the first antenna. In particular, device 10 initially sends two probe signals using the first (“1”) antenna. Device 10 then sends two probe signals using the second (“2”) antenna. Finally, device 10 sends two more probe signals using the first antenna. For each signal transmission, the transmit power of the probe signal is incremented (in this example). If desired, some of the probe signals may be sent using the same transmit power. Moreover, any suitable number of probe signals may be transmitted using each antenna (e.g., two or more, three or more, etc.) before switching to the other antenna.

FIG. 7 shows how different numbers of probe signals may be sent by each antenna. In the FIG. 7 example, device 10 favors the second antenna and therefore sends twice as many probe signals using the second (“2”) antenna as are sent with the first (“1”) antenna. Random antenna patterns and other antenna usage patterns may also be used if desired.

In the FIG. 8 example, device 10 is transmitting network access probe signals using three antennas. The power that is used in transmitting the antennas is incremented after each transmission. The antennas are used in rotation (e.g., rotating through first antenna “1,” second antenna “2,” third antenna “3,” fourth antenna “1,” and so forth). In schemes with more than three antennas (e.g., schemes with four antennas), the same type of pattern can be used (e.g., using the pattern “1,” “2,” “3,” “4,” “1,” “2,” etc.).

Combinations of these patterns or other suitable patterns may also be used. In general, the antenna number selection may be changed in an alternating fashion (e.g., in a two antenna configuration), in a rotating fashion (e.g., in a configuration with three or more antennas or four or more antennas), in a random fashion, in a pattern with multiple repeated uses of the same antenna, in an adaptive fashion based on measurements such as received signal power measurements or based on the occurrence of previous access probe failures, etc. The transmit power may be increased with each probe signal transmission, may be adjusted so as to not decrease with each new antenna selection, may be incremented by a predetermined amount for each probe signal transmission and/or new antenna selection, or may be otherwise adjusted.

The foregoing is merely illustrative of the principles of this invention and various modifications can be made by those skilled in the art without departing from the scope and spirit of the invention.

What is claimed is:

1. An electronic device configured to communicate with a wireless base station in a wireless network, comprising:
at least first and second antennas; and
radio-frequency transceiver circuitry configured to transmit network access probe signals for the base station through the first and second antennas.

2. The electronic device defined in claim 1 wherein the radio-frequency transceiver circuitry is configured to alternate between the first and second antennas when transmitting the network access probe signals.

3. The electronic device defined in claim 2 wherein the radio-frequency transceiver circuitry transmits each network access probe signal at a corresponding transmit power level and wherein the radio-frequency transmitter increments the transmit power level between transmissions of successive network access probe signals.

4. The electronic device defined in claim 1 wherein the radio-frequency transceiver circuitry comprises cellular telephone transceiver circuitry.

5. The electronic device defined in claim 1 wherein the radio-frequency transceiver circuitry comprises a first transceiver coupled to the first antenna and a second transceiver coupled to the second antenna.

6. The electronic device defined in claim 5 wherein the first transceiver comprises a first transmitter that is configured to transmit the network access probe signals through the first antenna and wherein the second transceiver comprises a second transmitter that is configured to transmit the network access probe signals through the second antenna.

7. The electronic device defined in claim 1 wherein the radio-frequency transceiver circuitry comprises a transmitter that transmits the network access probe signals, the electronic device further comprising:
switching circuitry interposed between the radio-frequency transceiver circuitry and the first and second antennas, wherein the switching circuitry is configurable to selectively couple the first or second antenna to the transmitter when transmitting the network access probe signals.

8. A method of transmitting network access probe signals to a base station in a wireless network, comprising:
with an electronic device having at least first and second antennas, transmitting the network access probe signals through the first antenna and through the second antenna.

9. The method defined in claim 8 wherein transmitting the network access probe signals comprises:
in alternation, transmitting the network access probe signals through the first antenna and transmitting the network access probe signals through the second antenna.

10. The method defined in claim 9 wherein each network access probe signal that is transmitted has an associated transmit power level, the method further comprising:
incrementing the transmit power level as each of the network access probe signals is transmitted in succession.

11. The method defined in claim 10 further comprising:
transmitting a plurality of sets of the network access probe signals each of which has network access probe signals with sequentially incremented transmit power levels and each of which includes at least some network access probe signals transmitted using the first antenna and at least some network access probe signals transmitted using the second antenna.

12. The method defined in claim 8 wherein transmitting the network access probe signals comprises:
transmitting at least a first network access probe signal through the first antenna without transmitting the first network access probe signal through the second antenna; and
transmitting at least a second network access probe signal through the second antenna without transmitting the second network access probe signal through the first antenna.

13. A method of obtaining wireless access from a wireless network with a base station using a wireless electronic device having at least first and second antennas, comprising:
with the wireless electronic device, transmitting a series of network access probe signals through the first and second antennas.

14. The method defined in claim 13 wherein transmitting the series of network access probe signals comprises alternating between transmission of a network access probe signal through the first antenna and transmission of a network access probe signal through the second antenna.

15. The method defined in claim 14 wherein transmitting the series of network access probe signals comprises transmitting a series of network access probe signals that each have a successively increased transmit power level.

16. The method defined in claim 15 further comprising:
following transmission of at least one of the network access probe signals, receiving a corresponding acknowledgement signal from the base station.

17. The method defined in claim 16 further comprising setting up a communication link between the electronic device and the base station in response to receiving the corresponding acknowledgement signal from the base station.

18. The method defined in claim 16 further comprising:
in response to receipt of the corresponding acknowledgement signal, setting up a cellular telephone communication link with the base station.

19. The method defined in claim 14 further comprising:
following transmission of a first of the network access probe signals at a first transmit power using the first antenna, awaiting receipt of a corresponding acknowledgement signal from the base station; and
in response to failure to receive an acknowledgement signal from the base station corresponding to the first of the network access probe signals, transmitting a second of the network access probe signals through the second antenna at a second transmit power that is greater than the first transmit power.

20. The method defined in claim 13 wherein transmitting the series of network access probe signals through the first and second antennas comprises configuring a switch to couple a radio-frequency transmitter alternately to the first and second antennas.
